(19) United States
(12) Patent Application Publication
(10) Pub. No.: US 2019/0042294 A1
(43) Pub. Date: Feb. 7, 2019

(54) System and method for implementing virtualized network functions with a shared memory pool

(71) Applicant: Intel Corporation, Santa Clara, CA (US)

(72) Inventors: Francesc Guim Bernat, Barcelona (ES); Karthik Kumar, Chandler, AZ (US); Timothy Verrall, Pleasant Hill, CA (US); Suraj Prabhakaran, Aachen (DE); Mark Schmisseur, Phoenix, AZ (US)

(21) Appl. No.: 15/952,274

(22) Filed: Apr. 13, 2018

(51) Int. Cl. G06F 9/455; G06F 9/50; H04L 29/08

(52) U.S. Cl. CPC G06F 9/45558; G06F 9/5016; H04L 67/26; H04L 41/0896; G06F 2009/45583; H04L 67/10; G06F 2009/45595

(57) ABSTRACT

A method and system for implementing virtualized network functions (VNFs) in a network. Physical resources of the network are abstracted into virtual resource pools and shared by virtual network entities. A virtual channel is set up for communicating data between a first VNF and a second VNF. A memory pool is allocated for the virtual channel from a set of memory pools. New interfaces are provided for communication between VNFs. The new interfaces may allow to push and pull payloads or data units from one VNF to another. The data may be stored in a queue in the pooled memory allocated for the VNFs/services. Certain processing may be performed before the data is stored in the memory pool.

### FIELD

Examples relate to network function virtualization, more particularly, a method and system for network function virtualization with a shared memory pool.

### BACKGROUND

Edge computing is a method of optimizing cloud computing systems by performing data processing at the edge of the network, near the source of the data. Computing platforms (e.g. compute nodes with memory and storage) are located close to the edge of the network to enable fast, real-time responses. This can reduce the latency and the needed communications bandwidth between data sources and the central data center. For example, a base station aggregation point in a cellular wireless communication network is one of the locations where the edge computing platform can be located. The edge itself can be hierarchical with different edge compute points.

Network function virtualization provides an architectural basis for replacing hardware appliances with virtual appliances by using virtualization technologies. Network function virtualization enables consolidation of network equipment types onto industry standard high-volume servers, switches and storage. Network function virtualization involves implementing network functions in software that can run on an industry standard server hardware, and that can be moved to, or instantiated in, various locations in the network without needing to install new equipment. Network function virtualization technology may provide significant benefits for network operators and their customers, such as lower capital expenditures and reduced operating costs.

### BRIEF DESCRIPTION OF THE FIGURES

Some examples of apparatuses and/or methods will be described in the following by way of example only, and with reference to the accompanying figures, in which

FIG. 1 shows an example edge cloud architecture;

FIG. 2 shows various services and applications for the edge cloud computing and associated resource usage and latency requirements;

FIG. 3 shows an example structure of a virtual edge appliance and an example workflow in the virtual edge appliance for communicating data between virtual network functions/services in accordance with one aspect; and

FIG. 4 is an example of a detailed architecture of a platform and a pooled memory in accordance with one aspect.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

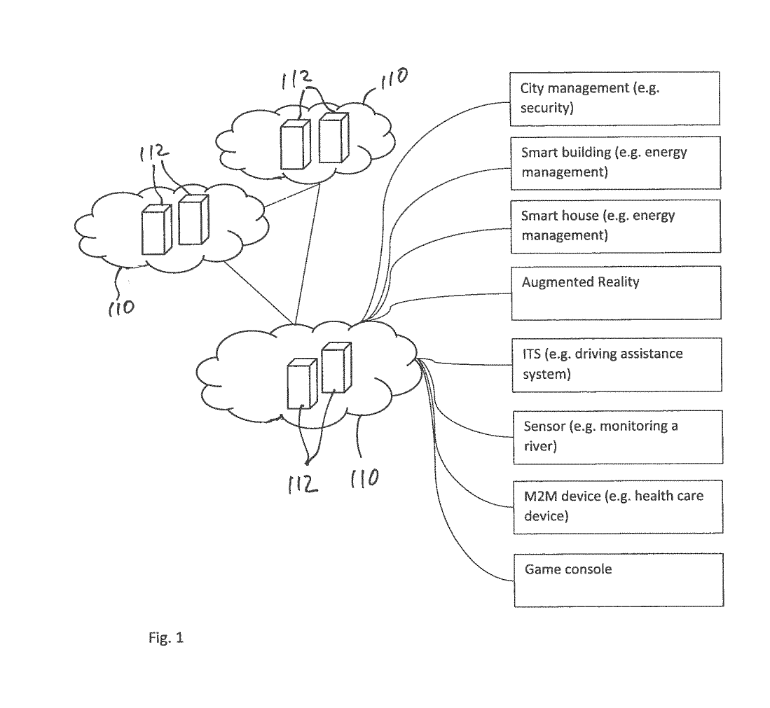

FIG. 1 shows an example edge cloud architecture. An edge computing platform (e.g. a server 112) in the edge cloud 110 may receive data from various sources, such as surveillance cameras (e.g. security cameras), sensors (e.g. monitoring a river), autonomous vehicles with a driving assistance system, smart buildings and houses (e.g. energy management), machine-to-machine (M2M) communication devices (e.g. health care devices), augmented reality devices, gaming consoles, or the like.

The data received from the sources often requires specialized and complex processing with low latency response requirements. For example, a surveillance system (e.g. for traffic monitoring for select vehicles, or facial recognition from public cameras, etc.) may require fast and efficient processing of videos in order to make real-time decisions. In the streaming video processing for such applications (e.g. face recognition), the end-to-end flow runs for the application and the functionalities are implemented on a server node(s).

Performing such processing for several concurrent streams imposes significant complexity in terms of processing requirements. The processing requirements may be handling hundreds or thousands of video feeds concurrently streaming into the edge cloud, handling spikes in payload with respect to the number of streams, performing targeted tasks (e.g. amber alert to locate vehicle X) across all the streams, performing varied and complex processing on each feed, using specialized hardware if required (e.g. field programmable gate arrays (FPGAs)), or returning the results in real-time.

The abstraction used to specify unit operations in the network function virtualization is a virtual network function (VNF). A VNF is a network function that is virtualized. A VNF may be offered as a network service or as a part of a network service including a set of virtualized network functions and/or non-virtualized network functions. A VNF is responsible for handling specific network functions that run in one or more virtual machines on top of the hardware networking infrastructure that may include routers, switches, servers, cloud computing systems, storage, or the like. For example, network functions like a Third Generation Partnership Project (3GPP) serving gateway (S-GW) or a firewall of a mobile network may be virtualized and implemented on commercial standardized servers. A single virtual S-GW or firewall may be implemented on a plurality of servers. Each server may host one or more modules of virtualized network functions that can be implemented as an application on the server.

The conventional approach for edge computing is to use commodity servers, and the components to perform the functions (e.g. resource management, scheduling, algorithms, or the like) are all implemented by software. However, in these architectures and the corresponding use cases, software cannot meet the low latency requirements to provide quick turn-around and highly optimize total cost of ownership (TCO) (e.g. using few resources when they are really needed, as hardware can be far more efficient in terms of resource overheads and avoiding memory to memory copy, etc.).

A conventional pool of servers situated in the edge cloud lacks the required set of hardware, and software handles the above requirements for the VNFs. Considering the complexity of the processing requirements discussed above there is a need for VNFs to be able to use a pool of memory and storage resources with compute capability.

In examples disclosed herein, the edge cloud architectures have the capability to efficiently and flexibly connect multiple VNFs and enable the VNFs to use pooled resources (e.g. pooled memory). In examples, a mechanism is provided to allow moving data flexibly between VNFs and sharing across multiple edge cloud entities.

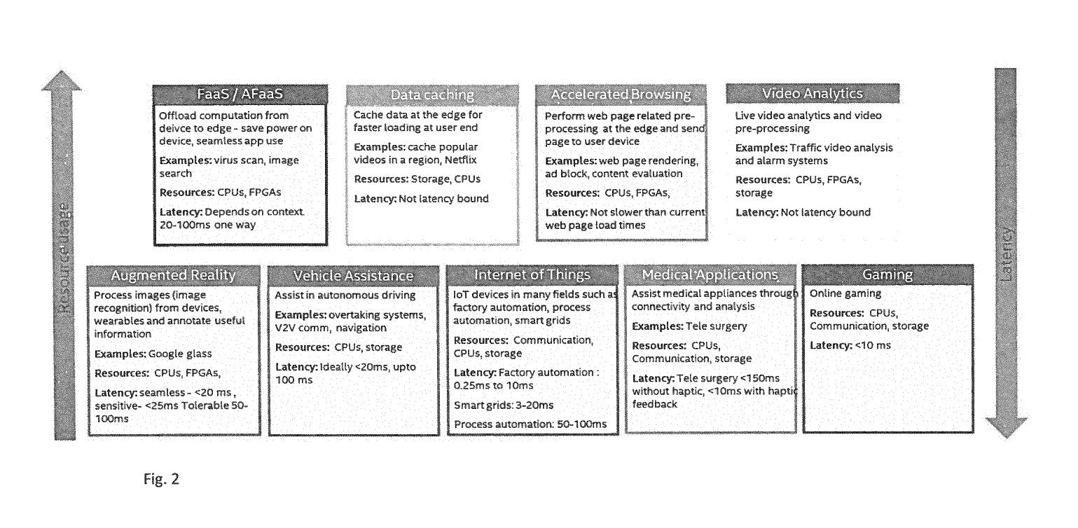

FIG. 2 shows various services and applications for the edge cloud computing and associated resource usage and latency requirements. The edge cloud is the next wave for data center growth, and the unique requirements for compute in the edge cloud necessitates the need for VNFs to leverage pooled memory and storage resources. The examples disclosed herein will allow the creation of a set of new services and business cases that are not possible with current technologies. The examples are applicable to a large variety of segments and workloads and may provide unique ways to dynamically and efficiently connect multiple communication streams via VNFs and services.

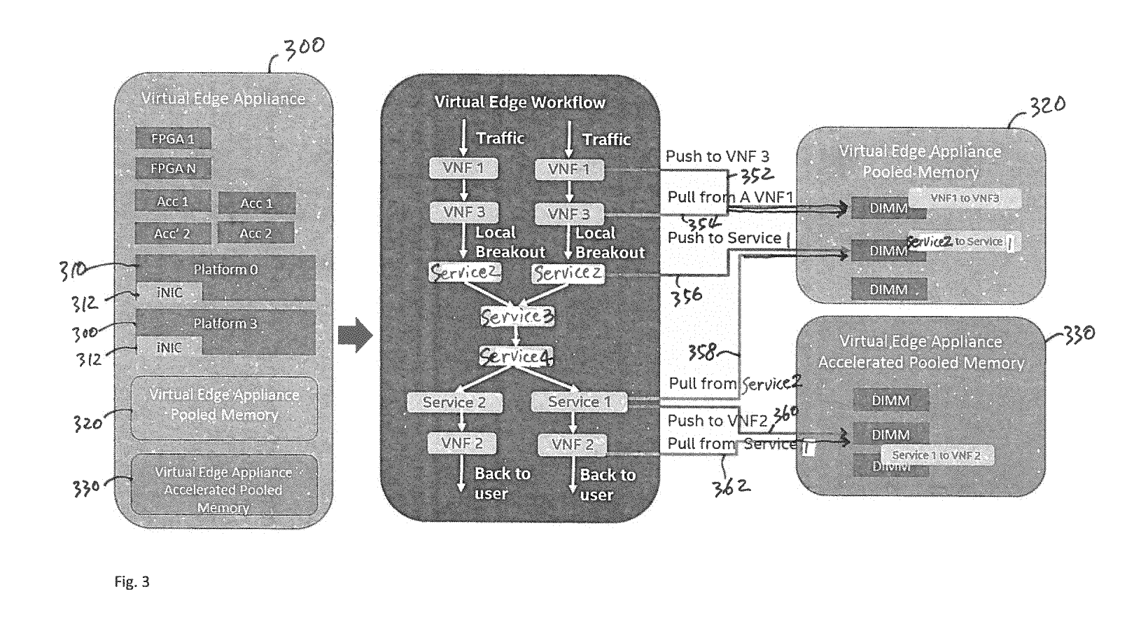

FIG. 3 shows an example structure of a virtual edge appliance 300 in accordance with one aspect. The virtual edge appliance 300 may be implemented on one or more servers/devices and each server/device may host one or more modules of VNFs and services of the virtual edge appliance 300. The terms “VNF” and “service” may be distinguished such that a VNF may be a function related to a data network (e.g. firewall, etc.) and a service may be a function not related to a data network (such as virus scanning, etc.). However, in examples disclosed herein, the terms “VNF” and “service” may be used interchangeably without distinction, and the term “VNF” may be used collectively including a service.

Using software component layers between physical hardware and VNFs, physical resources are abstracted. This provides a standardized software-based platform for running VNFs, regardless of the underlying hardware. Physical resources (e.g. compute resources, storage resources, network resources, etc.) provided by the network are abstracted into virtual resource pools and the virtual resource pools may be shared by multiple virtual network entities.

In examples, physical memory is pooled and a set of memory pools may be shared by a plurality of VNFs/services. A memory pool is a collection of physical memory that is accessible by multiple compute elements and is software configurable for access by those compute elements. Allocation of memory via software configuration maps some memory from the pool to each of the VNFs/services and can be done independent of the underlying hardware physical boundaries. The same memory may be allocated to multiple VNFs/services to provide a shared memory region between the VNFs/services. The term “memory” will be used as a generic term to include any data storage means. The pooled memory may include a (normal) pooled memory 320 and an accelerated pooled memory 330. The accelerated memory 330 is a memory with a hardware processor or capabilities for processing data (e.g. format conversion, etc.) before storing the data into the memory. The processing may be performed with a field programmable gate array (FPGA) or any hardware processor or accelerator, etc. The virtual edge appliance 300 includes a compute platform 310 including a network interface card (NIC) 312 (e.g. intelligent NIC (iNIC)).

In examples, new interfaces are provided for communication between VNFs (e.g. between VNFs, between services, between a VNF and a service, etc.). The new interfaces may allow to push payloads or data units (e.g. packets) from one VNF (or a service) to another. The data may be stored in a queue in the pooled memory allocated for the VNFs/services.

The new interfaces may also allow to pull payloads or data units from the pooled memory by a specific VNF (or service). For example, a VNF may access the pooled memory to retrieve data that has been pushed for the VNF. Alternatively, a VNF may pull from a generic queue, (i.e. pull any payload or data unit, for example a data unit meant to be consumed by a firewall VNF).

The new interfaces may also allow to create topologies in the pooled memory, for example to allocate corresponding queues. The point of delivery (POD) manager or a resource manager of a data center or a virtual edge appliance(s) may be extended to expose interfaces that allow to create and configure topologies. A topology is defined by a set of memory pools that are used to communicate between VNFs/services (e.g. between VNFs, between services, between a VNF and a service). For example, one memory pool may be used to communicate between VNF A and VNF B. The set of memory pools may include (normal) memory pools and/or accelerated memory pools. Each of the connections between VNFs/services through the allocated memory pool is referred to as a virtual channel. The virtual channel is set up, in part, by allocating a memory pool(s) from the set of memory pools.

FIG. 3 also shows an example workflow in the virtual edge appliance for communicating data between VNFs/services (right side of FIG. 3) in accordance with one aspect. In this example, a virtual channel is set up between VNF 1 and VNF 3, between service 2 and service 1, and between service 1 and VNF 2 so that these VNFs/services may communicate data via the corresponding virtual channel (e.g. via the allocated pooled memory/pooled accelerated memory).

In the example shown in FIG. 3, VNF 1 pushes data to VNF 3, e.g. by sending a push request to the NIC 312 (352). The NIC 312 may send the push request to a pooled memory control unit controlling a memory pool allocated for the virtual channel for VNF 1 and VNF 3. The data is stored in the memory pool (in this example, in a normal memory pool 320) allocated for communication between VNF 1 and VNF 3. After storing the data in the memory pool, VNF 3 may pull the data pushed by VNF 1, e.g. by sending a pull request to the NIC 312 (354). The NIC 312 may send the pull request to the pooled memory control unit controlling the memory pool allocated for the virtual channel for VNF 1 and VNF 3. The data may be then retrieved from the memory pool to VNF 3.

Service 2 pushes data to service 1, e.g. by sending a push request to the NIC 312 (356). The NIC 312 sends the push request to a pooled memory control unit controlling a memory pool allocated for the virtual channel for service 2 and service 1. The data is stored in the memory pool (in this example, in a normal memory pool 320) allocated for communication between service 2 and service 1. After storing the data in the memory pool, service 1 may pull the data pushed by service 2, e.g. by sending a pull request to the NIC 312 (358). The NIC 312 sends the pull request to the pooled memory control unit controlling the memory pool allocated for the virtual channel for service 2 and service 1. The data may be then retrieved from the memory pool to service 1.

Service 1 pushes data to VNF 2, e.g. by sending a push request to the NIC 312 (360). The NIC 312 sends the push request to a pooled memory control unit controlling a memory pool allocated for the virtual channel for service 1 and VNF 2. The data is stored in the memory pool (in this example, in an accelerated memory pool 330) allocated for communication between service 1 and VNF 2. A specific processing may be performed before storing the data in the accelerated memory pool 330. After storing the data in the memory pool, VNF 2 may pull the data pushed by service 1, e.g. by sending a pull request to the NIC 312 (362). The NIC 312 sends the pull request to the pooled memory control unit controlling the memory pool allocated for the virtual channel for service 1 and VNF 2. The data may be then retrieved from the memory pool to VNF 2.

Each virtual channel may be configured with a service level agreement (SLA) bandwidth requirements and/or resiliency requirements between different parts of the topology. For each virtual channel, a tenant (a user/customer) may specify the level of resiliency that is needed.

Based on the required resiliency, the POD manager or the resource manager may map the virtual channel to multiple physical memory pools. Every time data is sent through this virtual channel, the data may be automatically replicated in accordance with the configured level of resiliency. Similarly, when the data is pulled out of the pooled memory, the data may be removed from the multiple physical memory pools.

For each virtual channel, the tenant may specify bandwidth requirements. In order to meet the bandwidth requirements, the POD manager or the resource manager may allocate multiple physical memory pools to a particular virtual channel or, alternatively or additionally, configure a quality of service (QoS) bandwidth level from a physical memory pool to meet the bandwidth needs of the particular virtual channel. In this case, push requests to those memory pools are not replicated but may be distributed across the multiple physical memory pools to achieve the required bandwidth.

The architecture in accordance with examples disclosed herein implements the methodology using changes in the NIC 312 of the compute platform 310 to implement resiliency, quality of service (QoS), and load distribution when multiple queues are mapped between the same VNFs/services. Similar interfaces may also be implemented in the memory controllers 410 for the pooled memory/accelerated memory 320, 330.

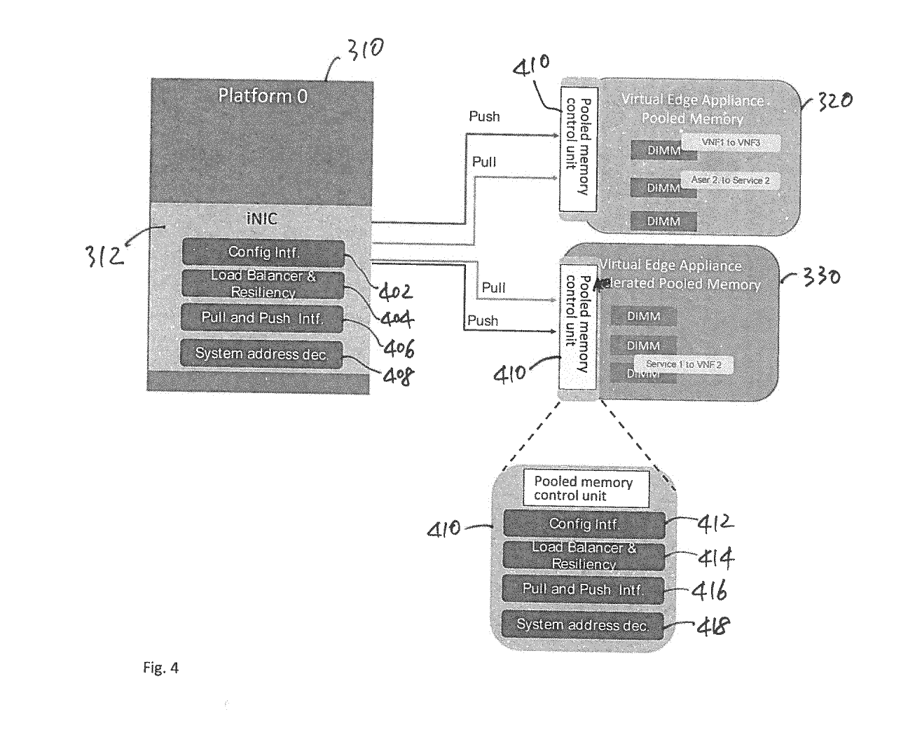

FIG. 4 is an example of a detailed architecture of a platform 310 and a pooled memory 320, 330 in accordance with one aspect. The platform 310 includes an NIC 312 (e.g. iNIC). The NIC 312 may be extended to act as a first level of interface and as a first level of intelligence in order to distribute push and pull requests from the VNFs/services across different pooled memories and storage schemes. For example, the extension of the NIC 312 may be implemented in the NIC FPGA.

The NIC may include a configuration interface 402 and a load balancing and resiliency controller 404 that may be configured by the POD manager or the resource manager. The configuration interface 402 may provide, for example, the capabilities of registering a VNF to the pooled memory control unit, deregistering a VNF to the pooled memory control unit, assigning certain permissions to a memory pool range, assigning a logical object at a certain address in the memory pool, de-assigning a logical object from a certain address in the memory pool, pushing a certain object onto the memory pool from a VNF, pulling a certain object from the memory pool to the VNF or to a queue where multiple VNFs can access it, changing the priority of a stream, etc.

The load balancing and resiliency controller 404 may be the one responsible to do the load balancing and replication of push/pull requests to the virtual channels based on the configuration that the specific connection (a virtual channel) has. For example, data sent on a virtual channel may be replicated to multiple physical memory pools or distributed across multiple physical memory pools depending on the level of resiliency or bandwidth requirement configuration. The load balancing and resiliency controller 404 may perform load balancing among push and pull requests from the VNFs/services based on certain criteria, e.g. QoS associated with the customer, traffic, etc.

The NIC 312 may include a system address decoder 408 that is used to discover to which physical memory pool a particular virtual channel for a VNF or service is to be mapped. For example, if a local VNF wants to push data to another VNF, the system address decoder 408 may determine the actual physical memory pool(s) mapped to the virtual channel. For example, in FIG. 4, the system address decoder 408 may determine whether the physical memory pools mapped for the virtual channel are regular pooled memory 320 or accelerated pooled memory 330 and send the push or pull request to the corresponding memory.

The NIC 312 may include pull and push interfaces 406. The pull and push interfaces 406 may be used by the VNFs or services (running in a local server or FPGAs) to push or pull data to and from different VNFs or services. The pull and push interfaces 406 may use the system address decoder 408 to decide to which physical memory pool or pools the pull or push requests need to be sent.

The pooled memory control unit 410 is provided to each of the pooled memory 320, 330. The pooled memory control unit 410 of the pooled memory 320, 330 may provide interfaces and logic for enabling communication of data between VNFs/services. There may be hundreds or thousands of VNFs all operating on several terabytes of data in the same edge cloud on the pooled memory.

The pooled memory control unit 410 may include a configuration interface 412. The configuration interface 412 for a memory pool may allow specifying memory physical address ranges to respective VNFs/services running on different compute resources and what read and/or write permissions the respective compute resources have. There may be bandwidth QoS settings such that the bandwidth to the memory pool can be reserved for some VNFs/services based on performance requirements. Other configuration settings may include resilience/replication requirements for the SLA of VNFs/services that have memory allocated from the memory pool.

The pooled memory control unit 410 may include a load balancing and resiliency controller 414. The load balancing and resiliency controller 414 may perform load balancing among push and pull requests received from the NIC 312 based on certain criteria, e.g. QoS associated with the customer, traffic, etc. The load balancing and resiliency controller 414 may replicate or distribute push requests to multiple physical memory pools based on the configuration that the specific connection has (e.g. data may be replicated to multiple physical pools or distributed across multiple physical pools).

The pooled memory control unit 410 may include a system address decoder 418. The system address decoder 418 may determine the physical memory pool to which a particular VNF or service is mapped in response to the push and pull requests from the NIC 312.

The pooled memory control unit 410 may expose pull and push interfaces 416 to different NICs 312 so that the NICs 312 may push and pull data units for the VNFs or services (running in a local server or FPGAs) to and from the pooled memory 320, 330. The pull and push interfaces 416 may expose parameters to specify certain levels of QoS for the push and pull requests.

The pull and push interfaces 416 may also include a logic that manages the physical memory pools 320, 330 that are used to store data to be consumed by different VNFs or services. Each of these memory pools may be seen or implemented as a first-in first-out (FIFO) queue of data flow. Alternatively, the pooled memory control unit 410 may include a mechanism to sort or process data in different order that is associated to a particular pool (e.g. sort the queue data by priority or by QoS attached to the customer or tenant).

Another example is an apparatus for implementing virtualized network functions in a network. Physical resources of the network are abstracted into virtual resource pools that are shared by virtual network entities. The apparatus may include non-transitory machine-readable media configured to store executable machine-readable codes, and a processor circuit configured to execute the machine-readable codes. The machine-readable codes, if executed, may be operable for implementing a first virtual network function that is configured to push data to a second virtual network function via a virtual channel, and implementing a second virtual network function that is configured to pull the data via the virtual channel. The virtual channel may be set up for communicating data between the first virtual network function and the second virtual network function by allocating a memory pool from a set of memory pools, and the data is stored in, and retrieved from, the allocated memory pool.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

Example 1 is a method for implementing virtualized network functions in a network. Physical resources of the network are abstracted into virtual resource pools that are shared by virtual network entities. The method comprises setting up a virtual channel for communicating data between a first virtual network function and a second virtual network function, wherein a memory pool is allocated for the virtual channel from a set of memory pools, pushing, by the first virtual network function, data to the second virtual network function via the virtual channel, wherein the data is stored in the allocated memory pool, and/or pulling, by the second virtual network function, the data pushed by the first virtual network function via the virtual channel, wherein the data is pulled from the allocated memory pool.

Example 2 is the method of example 1, further comprising configuring the virtual channel with a level of resiliency, wherein multiple physical memory pools are allocated for the virtual channel and the data is replicated to the multiple physical memory pools based on the level of resiliency.

Example 3 is the method as in any one of examples 1-2, further comprising configuring the virtual channel with a bandwidth requirement, wherein multiple physical memory pools are allocated for the virtual channel and the data is distributed to the multiple physical memory pools based on the bandwidth requirement.

Example 4 is the method as in any one of examples 1-3, further comprising determining a physical memory pool to which the virtual channel is mapped, wherein a request for pushing the data and a request for pulling the data is sent to the determined physical memory pool.

Example 5 is the method as in any one of examples 1-4, wherein the set of memory pools includes an accelerated memory pool, and a predetermined processing is performed on the data before storing the data in the accelerated memory pool.

Example 6 is the method as in any one of examples 1-5, wherein the second virtual network function pulls the data that is destined for the second virtual network function from the allocated memory pool.

Example 7 is the method as in any one of examples 1-6, wherein the second virtual network function pulls the data in a generic queue type from the allocated memory pool.

Example 8 is the method as in any one of examples 1-7, wherein the data unit is stored in a FIFO queue in the allocated memory pool.

Example 9 is a system for implementing virtualized network functions in a network. Physical resources of the network are abstracted into virtual resource pools that are shared by a plurality of virtual network entities. The system comprises a computing platform including a network interface card and a set of memory pools. The network interface card includes a pull and push interface to be used by a virtual network function to push data to a second virtual network function via a virtual channel or to be used by the second virtual network function to pull the data from the first virtual network function via the virtual channel. The virtual channel is set up for communicating data between the first virtual network function and the second virtual network function by allocating a memory pool from the set of memory pools, and the data is stored in, and/or retrieved from, the allocated memory pool.

Example 10 is the system of example 9, wherein multiple physical memory pools are allocated for the virtual channel based on a level of resiliency or a bandwidth requirement.

Example 11 is the system of example 10, wherein the network interface card is configured to either replicate the data to the multiple physical memory pools based on the level of resiliency or distribute the data to the multiple physical memory pools based on the bandwidth requirement.

Example 12 is the system as in any one of examples 9-11, wherein the network interface card is configured to determine a physical memory pool to which the virtual channel is mapped, wherein a request for pushing the data and a request for pulling the data is sent to the determined physical memory pool.

Example 13 is the system as in any one of examples 9-12, wherein the set of memory pools includes an accelerated memory pool, and a predetermined processing is performed on the data before storing the data in the accelerated memory pool.

Example 14 is the system as in any one of examples 9-13, wherein the second virtual network function pulls the data that is destined for the second virtual network function from the allocated memory pool.

Example 15 is the system as in any one of examples 9-14, wherein the second virtual network function pulls the data in a generic queue type from the allocated memory pool.

Example 16 is the system as in any one of examples 9-15, wherein the data is stored in a FIFO queue in the allocated memory pool.

Example 17 is an apparatus for implementing virtualized network functions in a network. Physical resources of the network are abstracted into virtual resource pools that are shared by virtual network entities. The apparatus comprises non-transitory machine-readable media configured to store executable machine-readable codes, a processor circuit configured to execute the machine-readable codes, and a set of memory pools. The machine-readable codes, if executed, are operable for implementing a first virtual network function that is configured to push data to a second virtual network function via a virtual channel or implementing a second virtual network function that is configured to pull the data from the first virtual network function via the virtual channel. The virtual channel is set up for communicating data between the first virtual network function and the second virtual network function by allocating a memory pool from the set of memory pools, and the data is stored in, and retrieved from, the allocated memory pool.

Example 18 is the apparatus of example 17, wherein multiple physical memory pools are allocated for the virtual channel based on a level of resiliency or a bandwidth requirement, and the machine-readable codes, if executed, are operable for either replicating the data to the multiple physical memory pools based on the level of resiliency or distributing the data to the multiple physical memory pools based on the bandwidth requirement.

Example 19 is the apparatus as in any one of examples 17-18, wherein the machine-readable codes, if executed, are operable for determining a physical memory pool to which the virtual channel is mapped and sending a request for pushing the data or a request for pulling the data to the determined physical memory pool.

Example 20 is the apparatus as in any one of examples 17-19, wherein the set of memory pools includes an accelerated memory pool, and a predetermined processing is performed on the data before storing the data in the accelerated memory pool.

Example 21 is a system for implementing virtualized network functions in a network. Physical resources of the network are abstracted into virtual resource pools that are shared by a plurality of virtual network entities. The system comprises a means for computing including a network interface means and a set of memory pools. The network interface means includes a pull and push interface to be used by a first virtual network function to push data to a second virtual network function via a virtual channel or to be used by the second virtual network function to pull the data from the first virtual network function via the virtual channel. The virtual channel is set up for communicating data between the first virtual network function and the second virtual network function by allocating a memory pool from the set of memory pools, and the data is stored in, and retrieved from, the allocated memory pool.

Example 22 is the system of example 21, wherein multiple physical memory pools are allocated for the virtual channel based on a level of resiliency or a bandwidth requirement.

Example 23 is the system of example 22, wherein the network interface means is configured to either replicate the data to the multiple physical memory pools based on the level of resiliency or distribute the data to the multiple physical memory pools based on the bandwidth requirement.

Example 24 is the system as in any one of examples 21-23, wherein the network interface means is configured to determine a physical memory pool to which the virtual channel is mapped, wherein a request for pushing the data and a request for pulling the data is sent to the determined physical memory pool.

Example 25 is the system as in any one of examples 21-24, wherein the set of memory pools includes an accelerated memory pool, and a predetermined processing is performed on the data before storing the data in the accelerated memory pool.

Example 26 is the system as in any one of examples 21-25, wherein the second virtual network function pulls the data that is destined for the second virtual network function from the allocated memory pool.

Example 27 is the system as in any one of examples 21-26, wherein the second virtual network function pulls the data in a generic queue type from the allocated memory pool.

Example 28 is the system as in any one of examples 21-27, wherein the data is stored in a FIFO queue in the allocated memory pool.

Example 29 is a computer program having a program code for performing a method as in any one of the examples above.

Example 30 is a machine-readable storage including machine readable instructions, when executed, to implement a method or realize an apparatus as in any one of the examples above.

Example 31 is a machine-readable medium including code, when executed, to cause a machine to perform a method as in any of the examples above.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that —although a dependent claim may refer in the claims to a specific combination with one or more other claims —other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

What is claimed is:

1. A system for implementing virtualized network functions in a network, wherein physical resources of the network are abstracted into virtual resource pools that are shared by a plurality of virtual network entities, the system comprising:
a computing platform including a network interface card; and
a set of memory pools,
wherein the network interface card includes a pull and push interface to be used by a first virtual network function to push data to a second virtual network function via a virtual channel or to be used by the second virtual network function to pull the data from the first virtual network function via the virtual channel,
wherein the virtual channel is set up for communicating data between the first virtual network function and the second virtual network function by allocating a memory pool from the set of memory pools, and the data is stored in, or retrieved from, the allocated memory pool.

2. The system of claim 1, wherein multiple physical memory pools are allocated for the virtual channel based on a level of resiliency or a bandwidth requirement.

3. The system of claim 2, wherein the network interface card is configured to either replicate the data to the multiple physical memory pools based on the level of resiliency or distribute the data to the multiple physical memory pools based on the bandwidth requirement.

4. The system of claim 1, wherein the network interface card is configured to determine a physical memory pool to which the virtual channel is mapped, wherein a request for pushing the data and a request for pulling the data is sent to the determined physical memory pool.

5. The system of claim 1, wherein the set of memory pools includes an accelerated memory pool, and a predetermined processing is performed on the data before storing the data in the accelerated memory pool.

6. The system of claim 1, wherein the second virtual network function pulls the data that is destined for the second virtual network function from the allocated memory pool.

7. The system of claim 1, wherein the second virtual network function pulls the data in a generic queue type from the allocated memory pool.

8. The system of claim 1, wherein the data is stored in a first-in first-out (FIFO) queue in the allocated memory pool.

9. An apparatus for implementing virtualized network functions in a network, wherein physical resources of the network are abstracted into virtual resource pools that are shared by virtual network entities, the apparatus comprising:
non-transitory machine-readable media configured to store executable machine-readable codes;
a processor circuit configured to execute the machine-readable codes; and
a set of memory pools,
wherein the machine-readable codes, if executed, are operable for:
implementing a first virtual network function that is configured to push data to a second virtual network function via a virtual channel; or
implementing the second virtual network function that is configured to pull the data from the first virtual network function via the virtual channel,
wherein the virtual channel is set up for communicating data between the first virtual network function and the second virtual network function by allocating a memory pool from the set of memory pools, and the data is stored in, and retrieved from, the allocated memory pool.

10. The apparatus of claim 9, wherein multiple physical memory pools are allocated for the virtual channel based on a level of resiliency or a bandwidth requirement, and the machine-readable codes, if executed, are operable for either replicating the data to the multiple physical memory pools based on the level of resiliency or distributing the data to the multiple physical memory pools based on the bandwidth requirement.

11. The apparatus of claim 9, wherein the machine-readable codes, if executed, are operable for determining a physical memory pool to which the virtual channel is mapped and sending a request for pushing the data or a request for pulling the data to the determined physical memory pool.

12. The apparatus of claim 9, wherein the set of memory pools includes an accelerated memory pool, and a predetermined processing is performed on the data before storing the data in the accelerated memory pool.

13. A method for implementing virtualized network functions in a network, wherein physical resources of the network are abstracted into virtual resource pools that are shared by virtual network entities, the method comprising:
setting up a virtual channel for communicating data between a first virtual network function and a second virtual network function, wherein a memory pool is allocated for the virtual channel from a set of memory pools;
pushing, by the first virtual network function, data to the second virtual network function via the virtual channel, wherein the data is stored in the allocated memory pool; and
pulling, by the second virtual network function, the data pushed by the first virtual network function via the virtual channel, wherein the data is pulled from the allocated memory pool.

14. The method of claim 13, further comprising:
configuring the virtual channel with a level of resiliency, wherein multiple physical memory pools are allocated for the virtual channel and the data is replicated to the multiple physical memory pools based on the level of resiliency.

15. The method of claim 13, further comprising:
configuring the virtual channel with a bandwidth requirement, wherein multiple physical memory pools are allocated for the virtual channel and the data is distributed to the multiple physical memory pools based on the bandwidth requirement.

16. The method of claim 13, further comprising:
determining a physical memory pool to which the virtual channel is mapped, wherein a request for pushing the data and a request for pulling the data is sent to the determined physical memory pool.

17. The method of claim 13, wherein the set of memory pools includes an accelerated memory pool, and a predetermined processing is performed on the data before storing the data in the accelerated memory pool.

18. The method of claim 13, wherein the second virtual network function pulls the data that is destined for the second virtual network function from the allocated memory pool.

19. The method of claim 13, wherein the second virtual network function pulls the data in a generic queue type from the allocated memory pool.

20. The method of claim 13, wherein the data unit is stored in a first-in first-out (FIFO) queue in the allocated memory pool.
